(19) United States
(12) Patent Application Publication
(10) Pub. No.: US 2025/0086952 A1
(43) Pub. Date: Mar. 13, 2025

(54) METHOD OF EDGE-CLOUD FUSION-AWARE VISUAL PROMPT LARGE LANGUAGE MODEL

(71) Applicant: Kneron (Taiwan) Co., Ltd., Taipei City (TW)

(72) Inventors: JIE WU, San Diego, CA (US); BODONG ZHANG, San Diego, CA (US); Gen Sun, San Diego, CA (US); JUNJIE SU, San Diego, CA (US); Hsiang-Tsun Li, San Diego, CA (US); Chun-Chen Liu, Taipei City (TW)

(73) Assignee: Kneron (Taiwan) Co., Ltd., Taipei City (TW)

(21) Appl. No.: 18/410,971

(22) Filed: Jan. 11, 2024

Related U.S. Application Data
(60) Provisional application No. 63/537,202, filed on Sep. 8, 2023.

(51) Int. Cl. G06V 10/80; G06F 40/40; G06V 10/74; G06V 10/774; G06V 10/94

(52) U.S. Cl. CPC G06V 10/806; G06F 40/40; G06V 10/761; G06V 10/774; G06V 10/95

(57) ABSTRACT

A method for running an edge-cloud fusion-aware visual prompt large language model includes training a large language model feature encoder and a small feature extraction model, inputting knowledge-based text prompts to the large language model feature encoder in an edge device to generate a plurality of knowledge-based text embeddings, building a large language model database in the edge device according to the plurality of knowledge-based text embeddings, inputting a text prompt to the large language model feature encoder in the edge device to generate a text query embedding, comparing the text query embedding with the large language model database to generate a first similarity score, and if the first similarity score is larger than a first threshold, then inputting the text query embedding to the small feature extraction model to generate a first answer.

### CROSS REFERENCE TO RELATED APPLICATIONS

This application claims the benefit of U.S. Provisional Application No. 63/537,202, filed on Sep. 8, 2023. The content of the application is incorporated herein by reference.

### BACKGROUND OF THE INVENTION

### 1. Field of the Invention

The present invention relates to a large language model, especially to a method for running an edge-cloud fusion-aware visual prompt large language model.

### 2. Description of the Prior Art

As artificial intelligence evolves, large language models (LLMs) have begun to play a critical role in numerous applications, including information retrieval, sentiment analysis, and natural language understanding. These models, however, typically focus on textual data, leaving a vast amount of visual data largely unexploited. The inclusion of visual cues in language models could significantly enrich the quality of their predictions and provide more nuanced interpretations of real-world scenarios.

However, the integration of visual data processing into language models introduces a new set of challenges, particularly in terms of computational resource requirements and latency. Processing visual data requires substantial computational power and may result in increased latency, which is detrimental to user experience. This is especially true in real-time applications where immediate responses are critical. In light of these challenges, a new approach that effectively leverages visual data in large language models, while also addressing the computational and latency issues, is necessary.

### SUMMARY OF THE INVENTION

An embodiment proposes a method for running an edge-cloud fusion-aware visual prompt large language model including training a large language model feature encoder and a small feature extraction model, inputting knowledge-based text prompts to the large language model feature encoder in an edge device to generate a plurality of knowledge-based text embeddings, building a large language model database in the edge device according to the plurality of knowledge-based text embeddings, inputting a text prompt to the large language model feature encoder in the edge device to generate a text query embedding, comparing the text query embedding with the large language model database to generate a first similarity score, and if the first similarity score is larger than a first threshold, then inputting the text query embedding to the small feature extraction model to generate a first answer.

Another embodiment proposes a method for running an edge-cloud fusion-aware visual prompt large language model including training a visual-prompt image encoder, a fully connected linear projector, and a small feature extraction model, inputting knowledge-based image prompts to the visual-prompt image encoder in an edge device to generate a plurality of knowledge-based image embeddings, building a large language model database in the edge device according to the plurality of knowledge-based image embeddings, inputting an image prompt to the visual-prompt image encoder in the edge device to generate a visual representation, inputting the visual representation to the fully connected linear projector in the edge device to generate an image query embedding, comparing the image query embedding with the large language model database to generate a second similarity score, and if the second similarity score is larger than a second threshold, then inputting the image query embedding to the small feature extraction model to generate a second answer.

Another embodiment proposes a method for running an edge-cloud fusion-aware visual prompt large language model including training a visual-prompt image encoder, a fully connected linear projector, a large language model feature encoder and a small feature extraction model, inputting knowledge-based image prompts and knowledge-based text prompts to the visual-prompt image encoder and the large language model feature encoder respectively in an edge device to generate a plurality of knowledge-based image embeddings and a plurality of knowledge-based text embeddings, concatenating the plurality of knowledge-based image embeddings and the plurality of knowledge-based text embeddings to generate a plurality of concatenated knowledge-based embeddings, building a large language model database in the edge device according to the plurality of concatenated knowledge-based embeddings, inputting an image prompt to the visual-prompt image encoder in the edge device to generate a visual representation, inputting the visual representation to the fully connected linear projector in the edge device to generate an image query embedding, inputting a text prompt to the large language model feature encoder in the edge device to generate a text query embedding, concatenating the image query embedding and the text query embedding to generate a concatenated query embedding, comparing the concatenated query embedding with the large language model database to generate a third similarity score, and if the third similarity score is larger than a third threshold, then inputting the concatenated query embedding to the small feature extraction model to generate a third answer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram for an edge-cloud fusion-aware visual prompt large language model according to an embodiment of the present invention.

FIG. 2 is a flowchart of a method for running the edge-cloud fusion-aware visual prompt large language model according to an embodiment of the present invention.

FIG. 3 is a flowchart of a method for running the edge-cloud fusion-aware visual prompt large language model according to another embodiment of the present invention.

FIG. 4 is a flowchart of a method for running the edge-cloud fusion-aware visual prompt large language model according to another embodiment of the present invention.

### DETAILED DESCRIPTION

Edge devices are used to perform the processing tasks, such as extracting features from visual prompts, which reduces the computational load on the cloud and improves response time. Furthermore, the large language model processing, which is computation-intensive, is offloaded to the cloud, ensuring that edge devices are not overwhelmed, and users can enjoy a smooth experience. Meanwhile, applying the proposed small feature extraction model and large language model database can also speed up user's response time.

Moreover, our proposed model provides a solution that can adapt in real-time to change in the network environment and system load, showcasing impressive flexibility. This level of adaptability is crucial in an era where edge devices and network conditions can vary greatly and ensures the robust performance of the language model across different scenarios. Therefore, our motivation lies in advancing the capabilities of large language models by incorporating visual data processing and achieving this integration in an efficient, flexible manner by leveraging the edge-cloud fusion approach. The proposed edge-cloud fusion-aware visual prompt large language model will not only protect customer's privacy when running the large language model in the edge device but will also offload the work in the cloud by only uploading useful embeddings.

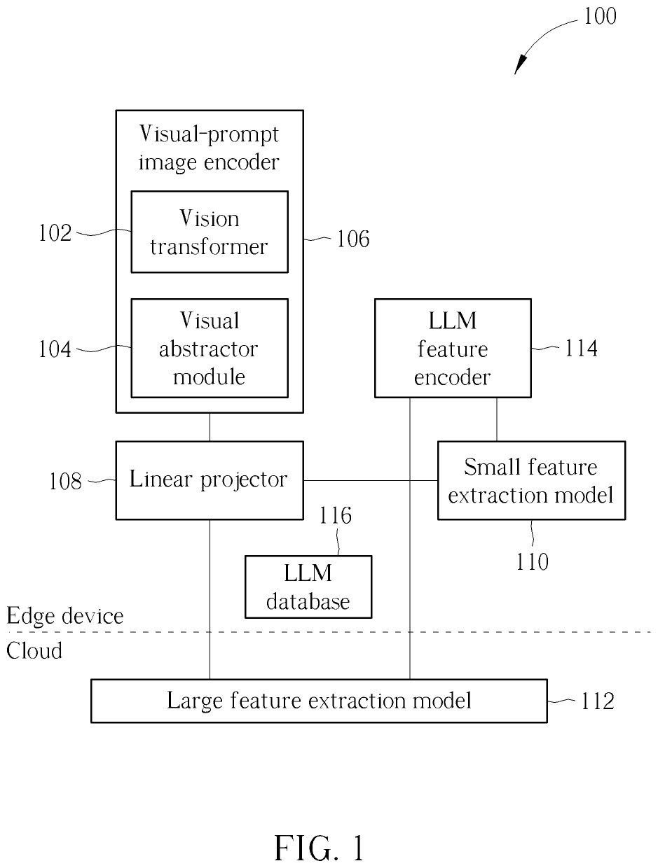

FIG. 1 is a block diagram for an edge-cloud fusion-aware visual prompt large language model 100 according to an embodiment of the present invention. The edge-cloud fusion-aware visual prompt large language model 100 comprises a visual-prompt image encoder 106, a fully connected linear projector 108 linked to the visual-prompt image encoder 106, a large language model (LLM) feature encoder 114, a large language model database 116, a small feature extraction model 110 linked to the fully connected linear projector 108 and the large language model feature encoder 114, and a large feature extraction model 112 linked to the fully connected linear projector 108 and the large language model feature encoder 114. The visual-prompt image encoder 106 may include a vision transformer 102 and a visual abstractor module 104. The visual-prompt image encoder 106, fully connected linear projector 108, large language model feature encoder 114, large language model database 116, a small feature extraction model 110 are trained in the cloud and run in an edge device. The large feature extraction model 112 is trained and run in the cloud.

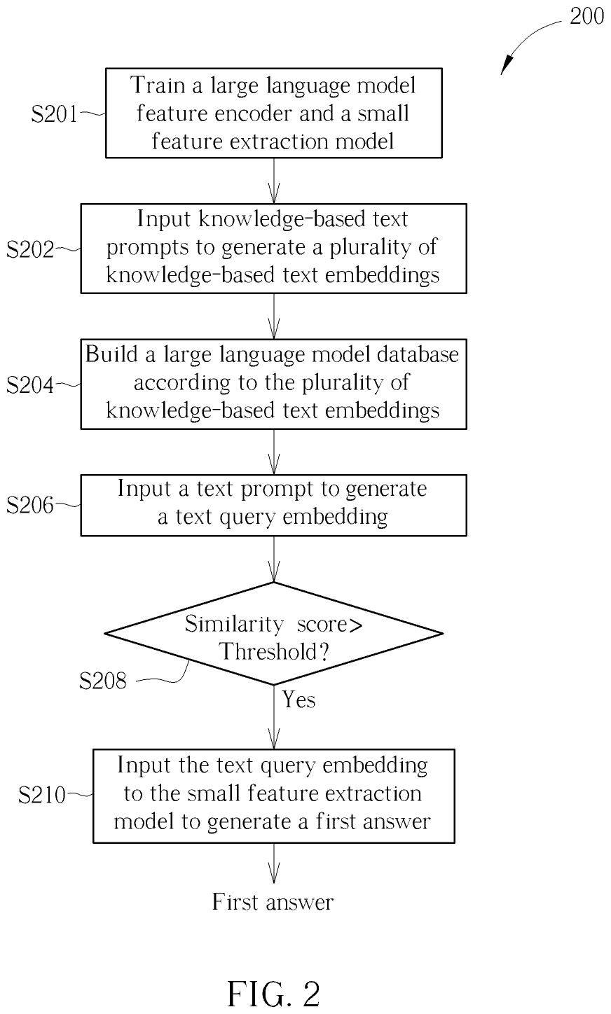

FIG. 2 is a flowchart of a method 200 for running the edge-cloud fusion-aware visual prompt large language model 100 according to an embodiment of the present invention. The method 200 is initiated in steps S202 and comprises the following steps:
Step S201: train the large language model feature encoder 114 and the small feature extraction model 110;
Step S202: input knowledge-based text prompts to the large language model feature encoder 114 to generate a plurality of knowledge-based text embeddings;
Step S204: build a large language model database 116 in the edge device according to the plurality of knowledge-based text embeddings;
Step S206: input a text prompt to the large language model feature encoder 114 in the edge device to generate a text query embedding;
Step S208: compare the text query embedding with the large language model database 116 in the edge device to generate a first similarity score; if the first similarity score is larger than a first threshold, then go to step S210; and
Step S210: input the text query embedding to the small feature extraction model 110 to generate a first answer.

In step S201, the large language model feature encoder 114 and the small feature extraction model 110 can be trained in the cloud. In step S202, knowledge-based text prompts are inputted to the large language model feature encoder 114 to generate a plurality of knowledge-based text embeddings. In step S204, a large language model database 116 is built in the edge device according to the plurality of knowledge-based text embeddings. In step S206, a text prompt is inputted to the large language model feature encoder 114 in the edge device to generate a text query embedding. In step S208, the text query embedding is compared with the large language model database 116 in the edge device to generate a first similarity score. if the first similarity score is larger than a first threshold, then go to step S210. In step S210, a text query embedding is inputted to the small feature extraction model 110 to generate a first answer. The first answer is the fast response to the text query embedding and is only implemented by the edge large language model feature encoder 114.

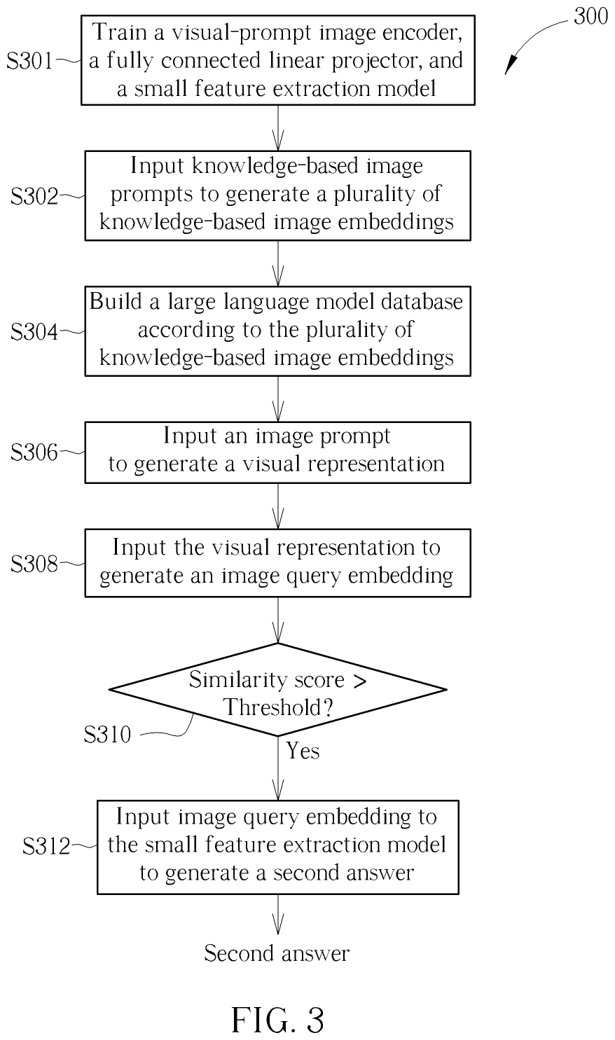

FIG. 3 is a flowchart of a method 300 for running the edge-cloud fusion-aware visual prompt large language model 100 according to another embodiment of the present invention. The method 300 is initiated in steps S302 and comprises the following steps:
Step S301: train the visual-prompt image encoder 106, the fully connected linear projector 108, and the small feature extraction model 110;
Step S302: input knowledge-based image prompts to the visual-prompt image encoder 106 to generate a plurality of knowledge-based image embeddings;
Step S304: build a large language model database 116 in the edge device according to the plurality of knowledge-based image embeddings;
Step S306: input an image prompt to the visual-prompt image encoder 106 to generate a visual representation;
Step S308: input the visual representation to the linear projector 108 to generate an image query embedding;
Step S310: compare the image query embedding with the large language model database 116 in the edge device to generate a second similarity score; if the second similarity score is larger than a second threshold, then go to step S312; and
Step S312: input the image query embedding to the small feature extraction model 110 to generate a second answer.

In step S301, the visual-prompt image encoder 106, the fully connected linear projector 108, and the small feature extraction model 110 can be trained in the cloud. In step S302, knowledge-based image prompts are inputted to the visual-prompt image encoder 106 to generate a plurality of knowledge-based image embeddings. In step S304, a large language model database 116 is built in the edge device according to the plurality of knowledge-based image embeddings. In step S306, an image prompt is inputted to the visual-prompt image encoder 106 to generate a visual representation. In step S308, the visual representation is inputted to the linear projector 108 to generate an image query embedding. In step S310, the image query embedding is compared with the large language model database 116 in the edge device to generate a second similarity score. If the second similarity score is larger than a second threshold, then go to step S312. In step S312, the image query embedding is inputted to the small feature extraction model 110 to generate a second answer. The second answer is the fast response to the image query embedding and is only implemented by the edge large language model feature encoder 114.

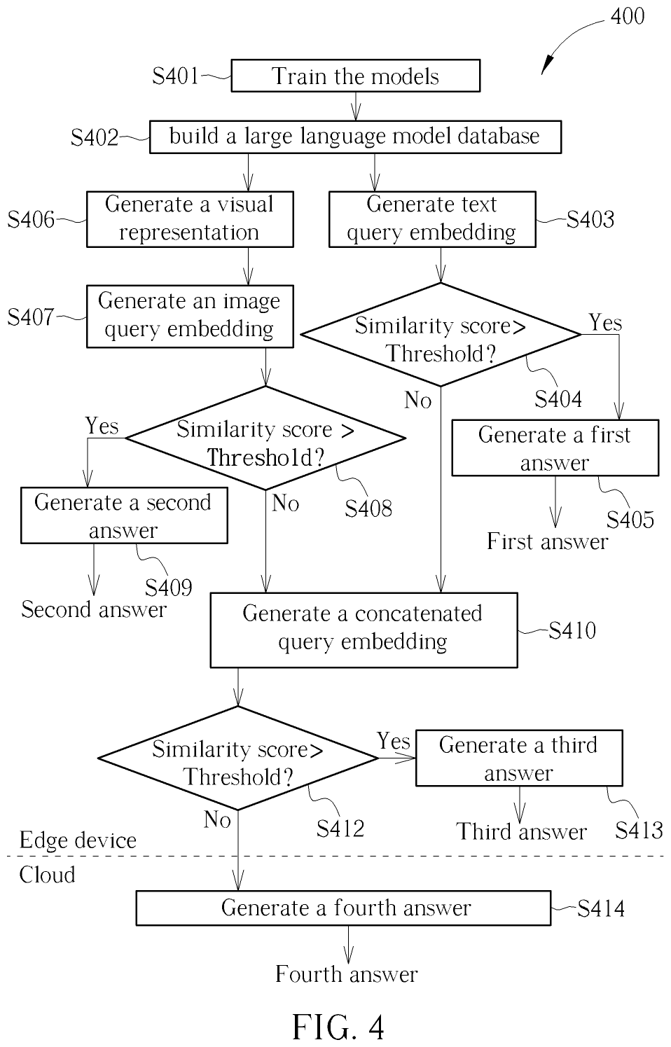

FIG. 4 is a flowchart of a method 400 for running the edge-cloud fusion-aware visual prompt large language model 100 according to another embodiment of the present invention. The method 400 is initiated in steps S401 and comprises the following steps:
Step S401: train the large language model feature encoder 114, the visual-prompt image encoder 106, the fully connected linear projector 108, and the small feature extraction model 110;
Step S402: build the large language model database 116;
Step S403: input a text prompt to the large language model feature encoder 114 in the edge device to generate a text query embedding;
Step S404: compare the text query embedding with items of the large language model database 116 in the edge device to generate a first similarity score; if the first similarity score is larger than a first threshold, then go to step S405; if the first similarity score is smaller than the first threshold, then go to step S410;
Step S405: input text query embedding to the small feature extraction model 110 to generate a first answer;
Step S406: input an image prompt to the visual-prompt image encoder 106 in the edge device to generate a visual representation;
Step S407: input the visual representation to the fully connected linear projector 108 in the edge device to generate an image query embedding;
Step S408: compare the image query embedding with items of the large language model database 116 in the edge device to generate a second similarity score; if the second similarity score is larger than a second threshold, then go to step S409; if the second similarity score is smaller than the second threshold, then go to step S410;
Step S409: input image query embedding to the small feature extraction model 110 to generate a second answer;
Step S410: concatenate the text query embedding and the image query embedding to generate a concatenated query embedding;
Step S412: compare the concatenated query embedding with the items of the large language model database 116 in the edge device to generate a third similarity score; if the third similarity score is larger than a third threshold, then go to step S413; if the third similarity score is smaller than the third threshold, then go to step S414;
Step S413: input the concatenated query embedding to the small feature extraction model 110 to generate a third answer; and
Step S414: input the concatenated query embedding to a large feature extraction model 112 in the cloud to return a fourth answer.

Before inference, the visual-prompt image encoder 106, the fully connected linear projector 108, the large language model feature encoder 114, the small feature extraction model 110, and the large feature extraction model 112 can be trained in the cloud in step S401. Then, input knowledge-based text prompts and knowledge-based image prompts to the large language model feature encoder 114 in the edge device to generate a plurality of knowledge-based text embeddings and knowledge-based image embeddings. The plurality of knowledge-based image embeddings and the plurality of knowledge-based text embeddings are concatenated to generate a plurality of concatenated knowledge-based embeddings. In step S402, build the large language model database 116 according to the plurality of concatenated knowledge-based embeddings, the plurality of knowledge-based image embeddings and the plurality of knowledge-based text embeddings.

During inference, in step S403, the text prompt is inputted to the large language model feature encoder 114 in the edge device to generate a text query embedding. In step S404, the text query embedding is compared with knowledge-based text embeddings of the first library in the large language model database 116 to find top k most similar embeddings in the first library. Then, an embedding best matching the text query embedding is selected from the top k most similar embeddings, and compared with the text query embedding to generate the first similarity score in step S404. If the first similarity score is larger than the first threshold, then go to step S405. If the first similarity score is smaller than the first threshold, go to step S410. In step S405, the text query embedding is inputted to the small feature extraction model 110 to generate a first answer. The first answer is the fast response to the text query embedding and is only implemented by the edge large language model feature encoder 114.

In step S406, the image prompt is inputted to the visual-prompt image encoder 106 in the edge device to generate the visual representation. The vision transformer 102 is a deep learning model based on the transformer architecture and uses self-attention mechanisms to extract visual features from the image prompts. Unlike convolutional neural networks, which rely on convolutional layers to extract local features from images, the vision transformer 102 uses self-attention mechanisms to capture global dependencies among image patches. This allows the vision transformer 102 to model relationships among distant image regions and to capture more complicated visual patterns. However, such complicated and dense visual features would fragment the fine-grained image information and bring large computation due to the lengthy sequence.

To mitigate this issue, the present embodiment employs the visual abstractor module 104 such as a Q-Former (query transformer). The Q-Former is a lightweight transformer that employs a set of learnable query vectors to extract visual features from the visual-prompt image encoder 106. It acts as an information bottleneck between the visual-prompt image encoder 106 and the edge-cloud fusion-aware visual prompt large language model 100. The Q-Former extracts the most useful language-informative visual representation while removing irrelevant visual information. In step S407, The visual representation is then inputted to the fully connected linear projector 108 in the edge device to generate an image query embedding. The linear projector 108 is implemented by using a deep neural network (DNN) to transform the dimension from the visual representation to the same dimension as the text query embedding.

In step S408, the image query embedding is compared with knowledge-based image embeddings of the second library in the large language model database 116 to find top k most similar embeddings in the second library. Then, an embedding best matching the image query embedding is selected from the top k most similar embeddings, and compared with the image query embedding to generate the second similarity score in step S408. If the second similarity score is larger than the second threshold, then go to step S409. If the second similarity score is smaller than the second threshold, go to step S410. In step S409, the image query embedding is inputted to the small feature extraction model 110 to generate a second answer. The second answer is the fast response to the image query embedding and is only implemented by the edge large language model feature encoder 114.

In step S410, the text query embedding and the image query embedding are concatenated to generate a concatenated query embedding. Then, in step S412, the concatenated query embedding is compared with concatenated knowledge-based embeddings of the third library in the large language model database 116 to find top k most similar embeddings in the third library. Then, an embedding best matching the concatenated query embedding is selected from the top k most similar embeddings, and compared with the concatenated query embedding to generate the third similarity score in step S412. If the third similarity score is larger than the third threshold, then go to step S413. If the third similarity score is smaller than the third threshold, then go to step S414. In step S413, the concatenated query embedding is inputted to the small feature extraction model 110 to generate a third answer. The third answer is the fast response to the concatenated query embedding and is only implemented by the edge large language model feature encoder 114. In step S414, the concatenated query embedding is inputted to the large feature extraction model 112 in the cloud to generate a fourth answer.

In the embodiment of the present invention, the large language model database 116 is initialized with the embedding results outputted by the large feature extraction model 112 in the cloud. All machine learning models except the large feature extraction model 112 are trained in the cloud and run in the edge device. The large feature extraction model 112 is trained and run in the cloud. By employing an edge-cloud collaborative architecture, this model strikes a balance between local and cloud computations, achieving an efficient use of resources and low latency. Simple answers can be replied in the edge device while complicated answers can be replied in the cloud. Moreover, the visual representation is transformed to be in the same dimension as the text embedding, thereby providing an accurate reply based on the edge-cloud fusion-aware visual prompt large language model 100.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for running an edge-cloud fusion-aware visual prompt large language model, comprising:
training a large language model feature encoder and a small feature extraction model;
inputting knowledge-based text prompts to the large language model feature encoder in an edge device to generate a plurality of knowledge-based text embeddings;
building a large language model database in the edge device according to the plurality of knowledge-based text embeddings;
inputting a text prompt to the large language model feature encoder in the edge device to generate a text query embedding;
comparing the text query embedding with the large language model database to generate a first similarity score; and
if the first similarity score is larger than a first threshold, then inputting the text query embedding to the small feature extraction model to generate a first answer.

2. The method of claim 1, wherein training the large language model feature encoder and the small feature extraction model is training the large language model feature encoder and the small feature extraction model in a cloud.

3. The method of claim 1, further comprising applying a first library to the large language model database;
wherein comparing the text query embedding with the large language model database to generate the first similarity score comprises:
comparing the text query embedding with the first library in the edge device to find k most similar embeddings in the first library;
selecting an embedding best matching the text query embedding from the k most similar embeddings; and
comparing the text query embedding with the embedding best matching the text query embedding to generate the first similarity score.

4. A method for running an edge-cloud fusion-aware visual prompt large language model, comprising:
training a visual-prompt image encoder, a fully connected linear projector, and a small feature extraction model;
inputting knowledge-based image prompts to the visual-prompt image encoder in an edge device to generate a plurality of knowledge-based image embeddings;
building a large language model database in the edge device according to the plurality of knowledge-based image embeddings;
inputting an image prompt to the visual-prompt image encoder in the edge device to generate a visual representation;
inputting the visual representation to the fully connected linear projector in the edge device to generate an image query embedding;
comparing the image query embedding with the large language model database to generate a second similarity score; and
if the second similarity score is larger than a second threshold, then inputting the image query embedding to the small feature extraction model to generate a second answer.

5. The method of claim 4, wherein training the visual-prompt image encoder, the fully connected linear projector, and the small feature extraction model is training the visual-prompt image encoder, the fully connected linear projector, and the small feature extraction model in a cloud.

6. The method of claim 4, further comprising applying a second library to the large language model database;
wherein comparing the image query embedding with the large language model database to generate the second similarity score comprises:
comparing the image query embedding with the second library in the edge device to find k most similar embeddings in the second library;
selecting an embedding best matching the image query embedding from the k most similar embeddings; and
comparing the image query embedding with the embedding best matching the image query embedding to generate the second similarity score.

7. The method of claim 4, wherein the visual-prompt image encoder comprises a vision transformer.

8. The method of claim 4, further comprising:
training the vision transformer to use a transformer architecture and a self-attention mechanism for extracting visual features from the image prompts.

9. The method of claim 8, wherein the visual-prompt image encoder comprises a visual abstractor module.

10. The method of claim 9, wherein the visual abstractor module is a Q-Former (query transformer).

11. The method of claim 10, further comprising:
inputting the visual features into the Q-Former to extract useful language-informative visual representation while removing irrelevant visual information.

12. A method for running an edge-cloud fusion-aware visual prompt large language model, comprising:
training a visual-prompt image encoder, a fully connected linear projector, a large language model feature encoder and a small feature extraction model;
inputting knowledge-based image prompts and knowledge-based text prompts to the visual-prompt image encoder and the large language model feature encoder respectively in an edge device to generate a plurality of knowledge-based image embeddings and a plurality of knowledge-based text embeddings;
concatenating the plurality of knowledge-based image embeddings and the plurality of knowledge-based text embeddings to generate a plurality of concatenated knowledge-based embeddings;
building a large language model database in the edge device according to the plurality of concatenated knowledge-based embeddings;
inputting an image prompt to the visual-prompt image encoder in the edge device to generate a visual representation;
inputting the visual representation to the fully connected linear projector in the edge device to generate an image query embedding;
inputting a text prompt to the large language model feature encoder in the edge device to generate a text query embedding;
concatenating the image query embedding and the text query embedding to generate a concatenated query embedding;
comparing the concatenated query embedding with the large language model database to generate a third similarity score; and
if the third similarity score is larger than a third threshold, then inputting the concatenated query embedding to the small feature extraction model to generate a third answer.

13. The method of claim 12, wherein training the visual-prompt image encoder, the fully connected linear projector, the large language model feature encoder and the small feature extraction model is training the visual-prompt image encoder, the fully connected linear projector, the large language model feature encoder and the small feature extraction model in a cloud.

14. The method of claim 12, further comprising applying a third library to the large language model database;
wherein comparing the concatenated query embedding with the large language model database to generate a third similarity score comprises:
comparing the concatenated query embedding with the third library in the edge device to find k most similar embeddings in the third library;
selecting an embedding best matching the concatenated query embedding from the k most similar embeddings; and
comparing the concatenated query embedding with the embedding best matching the concatenated query embedding to generate the third similarity score.

15. The method of claim 12, wherein the visual-prompt image encoder comprises a vision transformer.

16. The method of claim 12, further comprising:
training the vision transformer to use a transformer architecture and a self-attention mechanism for extracting visual features from the image prompts.

17. The method of claim 16, wherein the visual-prompt image encoder comprises a visual abstractor module.

18. The method of claim 17, wherein the visual abstractor module is a Q-Former (query transformer).

19. The method of claim 18, further comprising:
inputting the visual features into the Q-Former to extract useful language-informative visual representation while removing irrelevant visual information.

20. The method of claim 12, further comprising if the third similarity score is smaller than a third threshold, then inputting the concatenated query embedding to a large feature extraction model to generate a fourth answer.
